(19) United States
(12) Patent Application Publication
(10) Pub. No.: US 2018/0272617 A1
(43) Pub. Date: Sep. 27, 2018

(54) SEAL DEVICE

(71) Applicant: Fuji Impulse Co., Ltd., Osaka (JP)

(72) Inventors: Kazukuni Yamada, Osaka (JP); Yuichiro Kataoka, Osaka (JP); Kazuyoshi Tarumoto, Osaka (JP); Kenji Hara, Osaka (JP); Shunichi Iwamoto, Osaka (JP)

(21) Appl. No.: 15/963,589

(22) Filed: Apr. 26, 2018

Related U.S. Application Data
(63) Continuation of application No. 14/767,615, filed on Aug. 13, 2015, now abandoned.

(30) Foreign Application Priority Data
Feb. 15, 2013 (JP) 2013-027965

(51) Int. Cl. B29C 65/26; B29C 65/00; B29C 65/18

(52) U.S. Cl. CPC B29C 65/26; B29C 66/81821; B29K 2881/04; B29C 66/91421; B29C 66/82; B29C 66/0342; B29C 66/43121; B29C 66/91443; B29C 66/91231; B29C 66/81457; B29C 66/961; B29C 66/8324; B29C 66/81811; B29C 66/8221; B29C 66/1122; B29C 65/18; B29C 66/8161; B29C 66/8122; B29C 66/8227; B29K 2905/00; B29K 2905/02; B29C 66/91643

(57) ABSTRACT

A seal device includes a medium passage that sends a heating medium to a sealing units, the medium passage includes a heating medium passage portion for sending a heating medium to said communication part so as to heat the pressing part, a cooling medium passage portion for sending a cooling medium to the communication part so as to cool the pressing part, and a passage switch unit that switches between a state in which the heating medium passage portion and the communication part are connected, and a state in which the cooling medium passage portion and the communication part are connected.

### CROSS REFERENCE TO RELATED APPLICATIONS

This application is a continuation of U.S. application Ser. No. 14/767,615, filed Aug. 13, 2015, which is a national phase entry International Application No. PCT/JP2014/052871, filed Feb. 7, 2014, which claims priority to Japanese Application No. 2013-027965 filed Feb. 15, 2013, the entire contents of which are incorporated herein by reference.

### TECHNICAL FIELD

The present invention relates to a seal device equipped with a pair of pressing parts that sandwiches and presses an object to provide a seal.

### BACKGROUND ART

Seal devices equipped with a pair of pressing parts that sandwiches and presses an object to provide a seal have hitherto been known (for example, Patent Document 1). In such a seal device, one pressing part is formed by part of a pipe, inside which hot water is passed. This way, with one pressing part being heated, the pair of pressing parts sandwiches and presses an object (an opening of a bag, for example) to provide a seal.

Any displacement of a sealed portion of the object immediately after the sealing of the object may result in an insufficient seal in the molten sealed portion (e.g., a tight seal may not be formed inside the bag). Therefore, in such a seal device, the object needs to be retained after the object has been sealed until the molten sealed portion cures. This results in a lower processing speed and an increase in the scale of the device, leading to lower efficiency.

### PRIOR ART DOCUMENT

### Patent Document

Patent Document 1: JP-A-2006-335431

### SUMMARY OF THE INVENTION

### Problems to be Solved by the Invention

Accordingly, in consideration of such circumstances, an object of the present invention is to provide a seal device that can be operated with improved efficiency.

According to the present invention, there is provided a seal device, which includes:

a pair of sealing units each having a pressing part for sandwiching and pressing an object to provide a seal; and

a medium passage that sends a heating medium to at least one of said pair of sealing units,

said at least one sealing unit including a communication part for the heating medium to pass through for heat exchange between said pressing part and the heating medium, wherein

said medium passage includes a heating medium passage portion for sending a heating medium to said communication part so as to heat said pressing part of said at least one sealing unit, a cooling medium passage portion for sending a cooling medium to said communication part so as to cool said pressing part of said at least one sealing unit, and a passage switch unit that switches between a state in which said heating medium passage portion and said communication part are connected, and a state in which said cooling medium passage portion and said communication part are connected.

According to the present invention, the passage switch unit switches over to a state in which the heating medium passage portion is connected with the communication part so as to send the heating medium from the heating medium passage portion to the communication part. Thereby, the pressing part of at least one of the sealing units is heated, and the pair of pressing parts sandwiches and presses the object to provide a seal. At this time, the sealed portion of the object is molten.

The passage switch unit then switches over to a state in which the cooling medium passage portion is connected with the communication part so as to send the cooling medium from the cooling medium passage portion to the communication part. Thereby, the pressing part of at least one of the sealing units is cooled, so that the molten sealed portion cures. The object can thus be sealed.

Also, the seal device may have a configuration in which:

said one sealing unit further includes a sealing unit body that supports said pressing part,

said pressing part being disposed so as to protrude from said sealing unit body, and wherein

at least a side portion of said pressing part is configured to protrude from said sealing unit body in a decreasing amount toward an end.

In such a configuration, the pressing part is supported in the sealing unit body so as to protrude from the sealing unit body. At least in the side portions of the pressing part, the protruding amount of the pressing part protruding from the sealing unit body decreases toward the ends, so that, in the sealed portion of the object pressed by the pair of pressing parts, the thickness increases gradually toward the ends. The object can thus be sealed such that the end portions of the sealed portion of the object are hard to tear.

Also, the seal device may have a configuration in which:

said heating medium is a gas,

said medium passage includes a compressed gas passage portion for sending a compressed gas to said communication part, and

said passage switch unit is switched over to send the compressed gas to said communication part before the heating medium is sent to said communication part.

In such a configuration, by the switching of the passage switch unit, the compressed gas is sent from the compressed gas passage portion to the communication part before the heating medium, which is a gas, is sent from the heating medium passage portion to the communication part. Therefore, when the heating medium is sent to the communication part, any liquid (such as condensate liquid of the heating medium, or cooling medium, for example) is prevented from remaining inside the communication part. It is thereby prevented that the heating medium gives up its heat to such a liquid, so that the heat of the heating medium can be utilized effectively to heat the pressing part.

Also, the seal device may have a configuration in which:

said communication part is formed to have an arcuate inner surface at least on a lower side.

In such a configuration, the communication part has an arcuate inner surface at least in the lower part, so that the liquid remaining inside the communication part (such as condensate liquid of the heating medium, or cooling medium, for example) is collected in the arcuate lower part of the communication part. Therefore, by sending the compressed gas from the compressed gas passage portion to the communication part, such liquid can be drained reliably from the inside of the communication part. This way, any such liquid can be prevented from remaining inside the communication part reliably when the heating medium is sent to the communication part.

Also, the seal device may have a configuration in which:

said cooling medium is a liquid;

said medium passage includes a compressed gas passage portion for sending a compressed gas to said communication part; and

when the cooling medium is sent to said communication part, said passage switch unit is switched over to send the compressed gas to said communication part with the cooling medium.

In such a configuration, when the cooling medium, which is a liquid, is sent from the cooling medium passage portion to the communication part, the compressed gas is sent from the compressed gas passage portion to the communication part with the cooling medium by the switching of the passage switch unit, so that the cooling medium mixes with the compressed gas. Thereby, with the cooling medium atomized, for example, the heat of evaporation (latent heat) effectively acts to lower the temperature of the pressing part. The cooling medium can also create a turbulence, for example, inside the communication part to provide a stirring effect, to make the temperature of the cooling medium uniform, whereby the heat exchange between the cooling medium and the pressing part takes place effectively.

### Effects of the Invention

As described above, the seal device according to the present invention provides the excellent effects of improving efficiency.

### BRIEF DESCRIPTION OF THE DRAWINGS

FIG. 1 is a side view showing essential parts of a seal device according to one embodiment of the present invention.

FIG. 2 is a front view showing essential parts of the seal device according to the embodiment.

FIG. 3 is a longitudinal cross-sectional view showing essential parts of a pair of sealing units according to the embodiment.

FIG. 4 is a block diagram of the seal device according to the embodiment.

FIG. 5 is a diagram explaining the operation of the pair of sealing units according to the embodiment and shows a longitudinal cross-sectional view of essential parts.

FIG. 6 is a diagram explaining the operation of the pair of sealing units according to the embodiment and shows a longitudinal cross-sectional view of essential parts.

FIG. 7 is a flowchart of the seal device according to the embodiment.

FIG. 8 is a time chart of the seal device according to the embodiment.

FIG. 9 is a longitudinal cross-sectional view showing essential parts of a sealing unit according to another embodiment of the present invention.

FIG. 10 is a longitudinal cross-sectional view showing essential parts of a sealing unit according to yet another embodiment of the present invention.

### MODE FOR CARRYING OUT THE INVENTION

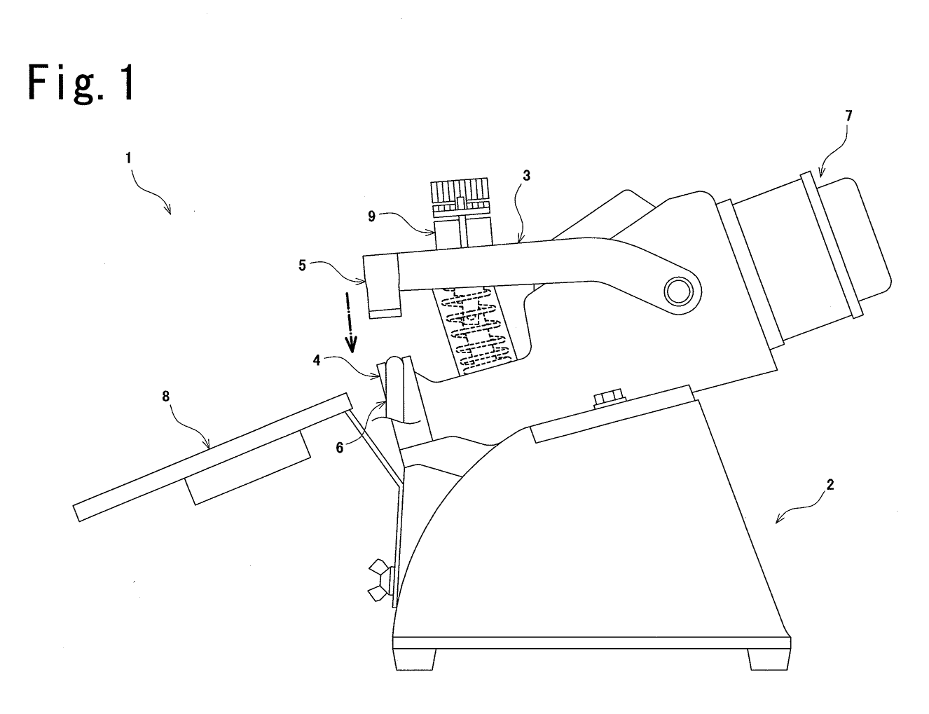

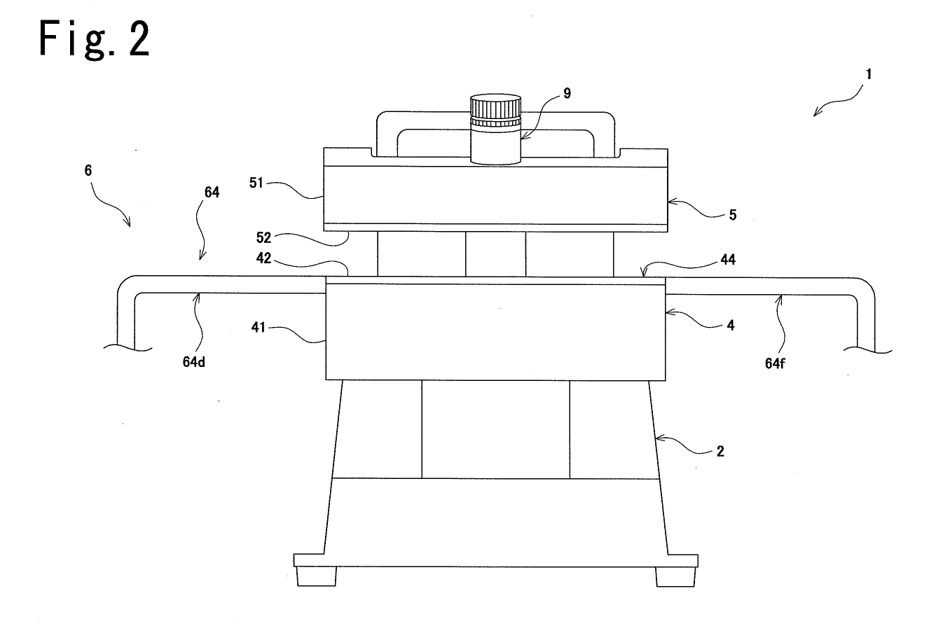

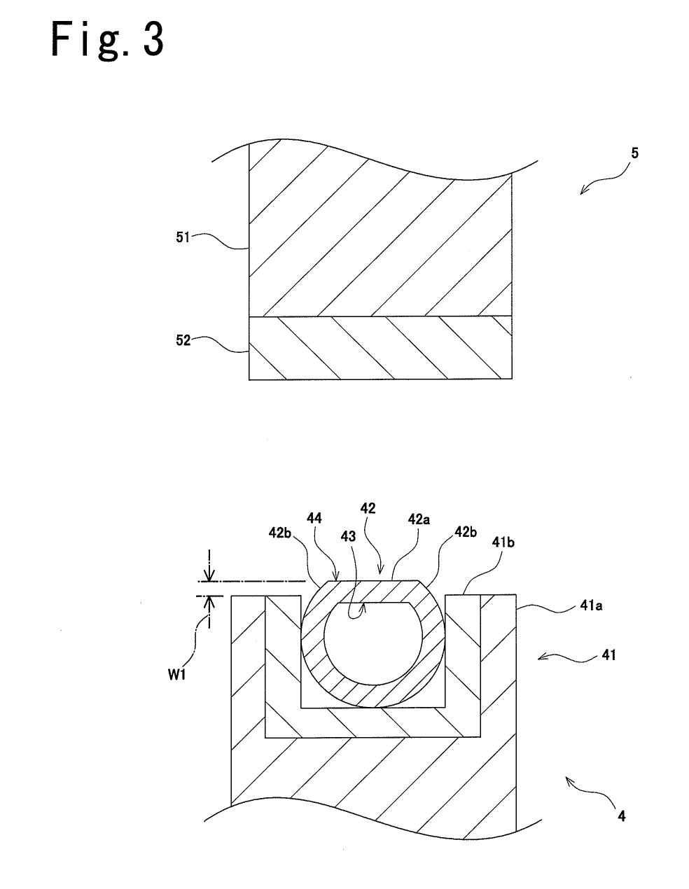

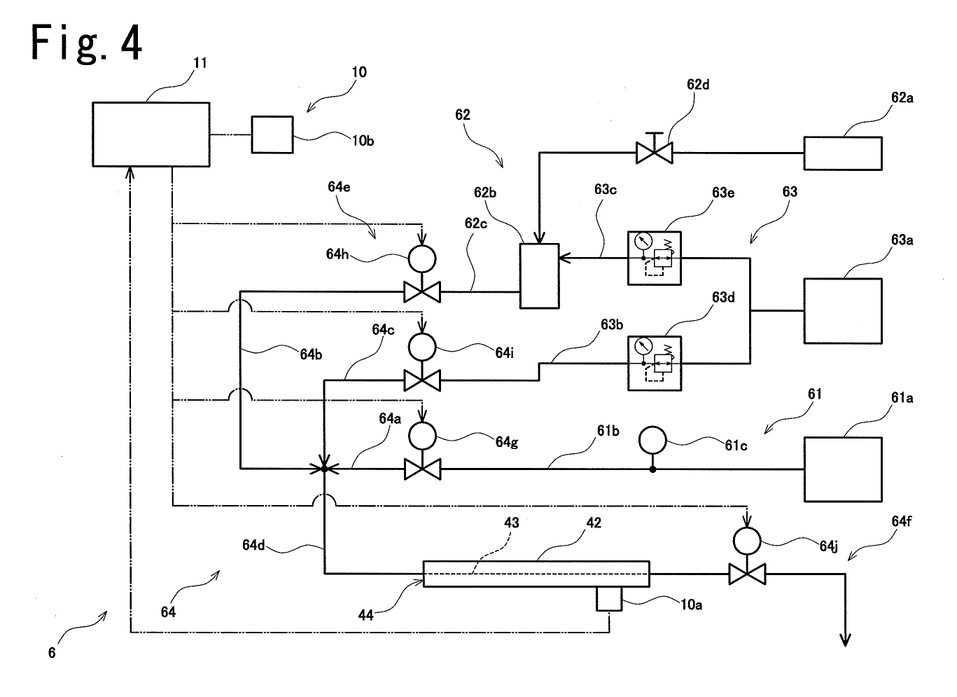

Hereinafter, one embodiment of a seal device according to the present invention will be described with reference to FIG. 1 to FIG. 8.

As shown in FIG. 1 to FIG. 4, a seal device 1 according to this embodiment includes a device main body 2 and a movable body 3 movable relative to the device main body 2. The seal device 1 also includes a first sealing unit 4 and a second sealing unit 5 that move toward and away from each other to sandwich an object (such as an opening of a bag, for example) to provide a seal, and a medium supply unit 6 that supplies a heating medium to the first sealing unit 4.

The seal device 1 includes a drive unit 7 for moving the movable body 3, a support unit 8 fixed to the device main body 2 for supporting the object placed thereon, and a pressure adjustment unit 9 that changes the pressure applied on the object by the pair of sealing units 4 and 5. The seal device 1 further includes an input unit 10 for inputting instructions and information, and a control unit 11 that performs various control operations.

The device main body 2 has the first sealing unit 4 secured thereto. The movable body 3 is formed in an elongated shape. The base end of the movable body 3 is attached rotatably to the device main body 2, while the distal end of the movable body 3 has the second sealing unit 5 fixed thereto. Therefore, when the drive unit 7 drives the movable body 3 to turn around its base end, the pair of sealing units 4 and 5 moves toward and away from each other.

The first sealing unit 4 includes a long first sealing unit body 41 coupled to an upper end portion of the device main body 2. The first sealing unit 4 also includes a first pressing part 42 for sandwiching and pressing an object between the first sealing unit 4 and the second sealing unit 5, and a communication part 43 for a heating medium to pass through for heat exchange between the first pressing part 42 and the heating medium. In this embodiment, the first sealing unit 4 includes a pipe 44, and part of the pipe 44 forms the first pressing part 42, while the inside of the pipe 44 forms the communication part 43.

The first sealing unit body 41 includes a base part 41a coupled to the device main body 2, and a heat insulation part 41b disposed between the base part 41a and the pipe 44. In this embodiment, the base part 41a is made of metal (such as aluminum, for example), while the heat insulation part 41b is made of a heat-resistant hard resin (such as phenolic resin or polyphenylene sulfide resin, for example).

The base part 41a has a recessed portion open upwards in an upper part, with the heat insulation part 41b being fitted in this recessed portion and thereby retained. The heat insulation part 41b includes a recessed portion open upwards, with the pipe 44 being accommodated in this recessed portion and thereby supported. The first sealing unit body 41 thus supports the first pressing part 42.

The first pressing part 42 includes a flat central portion 42a and curved side portions 42b. The first pressing part 42 is arranged at the upper end of the first sealing unit 4. The first pressing part 42 is disposed so as to protrude from the first sealing unit body 41. More specifically, the first pressing part 42 is formed by a portion of the pipe 44 upwardly protruding from the first sealing unit 41.

The pipe 44 is formed by processing a part of a cylindrical tube to have a flat portion. The flat portion of the pipe 44 is positioned at the top. The flat portion is located so as to protrude from the first sealing unit body 41, thereby forming the central portion 42a of the first pressing part 42.

Therefore, the protruding amount W1 in the central portion 42a in the widthwise direction of the first pressing part 42 protruding from the sealing unit body 41 is constant, while the protruding amount W1 of each side portion 42b in the widthwise direction protruding from the sealing unit body 41 reduces toward the ends in the widthwise direction. In a cross section orthogonal to the longitudinal direction, the upper inner surface of the communication part 43 is formed flat, while the lateral and lower inner surfaces of the communication part 43 are formed in an arcuate form. In this embodiment, the pipe 44 is made of a metal having high heat conductivity (such as copper, for example).

The second sealing unit 5 includes a long second sealing unit body 51 coupled to the distal end of the movable body 3, and a second pressing part 52 that sandwiches and presses the object between the second pressing part 52 and the first pressing part 42. In this embodiment, the second sealing unit body 51 is made of metal (such as aluminum, for example), while the second pressing part 52 is made of resin (such as silicone rubber, for example).

The second pressing part 52 is located at the lower end of the second sealing unit 5. More specifically, the second pressing part 52 is coupled to the lower end of the second sealing unit body 51. The second pressing part 52 is formed generally flat as a whole. The second pressing part 52 has elasticity to undergo elastic deformation when pressing the object between the second pressing part 52 and the first pressing part 42.

The medium supply unit 6 includes a heating medium supply unit 61 that supplies a heating medium, a cooling medium supply unit 62 that supplies a cooling medium, and a compressed gas supply unit 63 that supplies compressed gas. The medium supply unit 6 further includes a medium passage 64 for delivering each medium and the compressed gas to the first sealing unit 4.

The heating medium supply unit 61 includes a heating medium source 61a, and a supply passage 61b for sending the heating medium from the heating medium source 61a to the medium passage 64. In this embodiment, the heating medium is a gas, and more particularly, steam. Namely, in this embodiment, the heating medium source 61a is a boiler. The heating medium supply unit 61 includes a pressure detection unit (for example barometer) 61c that detects (measures) the pressure of the heating medium.

The cooling medium supply unit 62 includes a cooling medium source 62a, a tank 62b that stores the cooling medium, and a supply passage 62c for sending the cooling medium from the tank 62b to the medium passage 64. In this embodiment, the cooling medium is a liquid, and more particularly, cold water. The cooling medium supply unit 62 includes a valve 62d that is opened when the cooling medium is to be supplied from the cooling medium source 62a to the tank 62b.

The compressed gas supply unit 63 includes a compressed gas source 63a, a supply passage 63b for sending the compressed gas from the compressed gas source 63a to the medium passage 64, and a pressurizing passage 63c for sending the compressed gas to the tank 62b to pressurize the tank 62b in the cooling medium supply unit 62. In this embodiment, the compressed gas is compressed air, and the compressed gas source 63a is a compressor.

The compressed gas supply unit 63 also includes pressure adjustment units (such as a gauged regulator, for example) 63d and 63e so that the pressure can be changed individually in each of the supply passage 63b and the pressurizing passage 63c. By making changes in the pressure adjustment units 63d and 63e, the mixture ratio of the cooling medium and compressed gas (i.e., flow amount of the cooling medium) sent to the communication part 43 can be changed.

The medium passage 64 includes a heating medium passage portion 64a for sending the heating medium to the communication part 43 of the first sealing unit 4, a cooling medium passage portion 64b for sending the cooling medium to the communication part 43, and a compressed gas passage portion 64c for sending the compressed gas to the communication part 43. The medium passage 64 also includes a common passage portion 64d that connects the respective passage portions 64a to 64c with the communication part 43.

The medium passage 64 includes a passage switch unit 64e for switchably connecting the respective passage portions 64a to 64c with the communication part 43 via the common passage portion 64d. The medium passage 64 further includes a discharge passage portion 64f for discharging each medium from the communication part 43.

The passage switch unit 64e includes a heating medium valve 64g that opens and closes the communication between the heating medium supply unit 61 and the heating medium passage portion 64a, a cooling medium valve 64h that opens and closes the communication between the cooling medium supply unit 62 and the cooling medium passage portion 64b, and a compressed gas valve 64i that opens and closes the communication between the compressed gas supply unit 63 and the compressed gas passage portion 64c. The discharge passage portion 64f includes a discharge valve 64j that opens and closes the communication between the communication part 43 and the outside of the device 1.

The input unit 10 includes a temperature detection unit 10a that detects the temperature of the first pressing part 42, and an operation part 10b operated by an operator when initiating a sealing operation. The information acquired by detection at the temperature detection unit 10a and the information regarding the operation of the operation part 10b are sent to the control unit 11. The control unit 11 controls the opening and closing of each of the valves 64g to 64j based on the information from the temperature detection unit 10a and the operation part 10b.

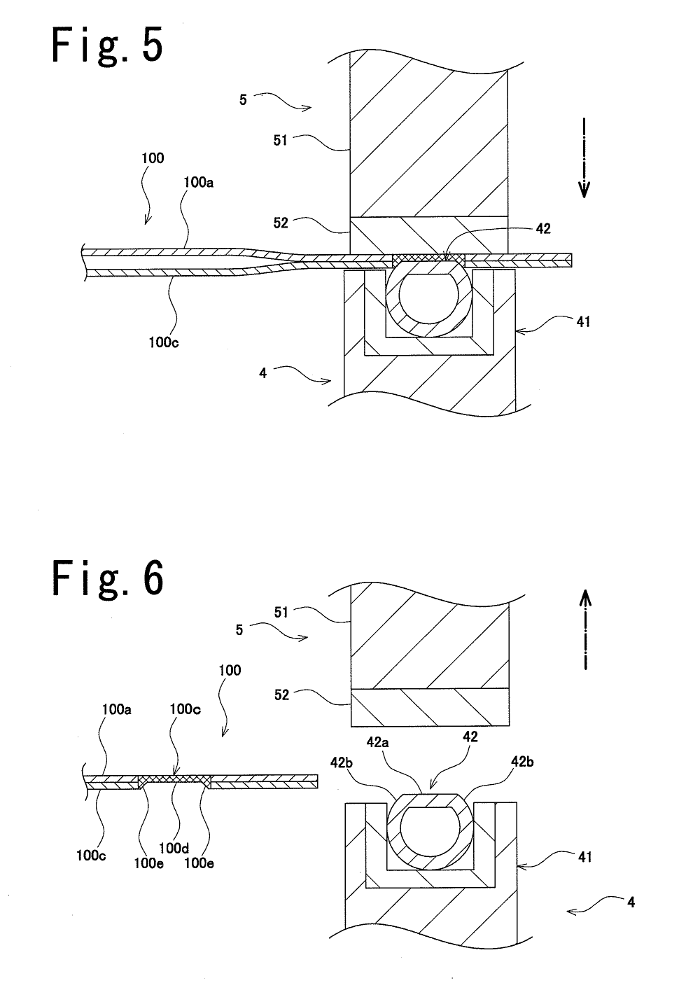

The seal device 1 according to this embodiment is configured as described above. Next, the sealing method with the use of the seal device 1 according to this embodiment will be described with reference to FIG. 5 and FIG. 6.

After an object 100 is inserted between the pair of sealing units 4 and 5, the operation part 10b is operated, whereby the second sealing unit 5 moves down to approach the first sealing unit 4, as shown in FIG. 5. With the pair of pressing parts 42 and 52 pressing the object 100, the first pressing part 42 is heated, and then cooled thereafter. This way, a first portion 100a and a second portion 100b of the object 100 are molten and then cured thereafter in a sealed portion 100c (hatched area in FIG. 5 and FIG. 6), and the object 100 is thus sealed in the sealed portion 100c.

After that, the second sealing unit 5 moves up to separate from the first sealing unit 4, and the object 100 is removed from the pair of sealing units 4 and 5. A central portion 100d of the sealed portion 100c has a constant thickness and a predetermined width, since the central portion 100d was pressed by the flat central portion 42a of the first pressing part 42 and the flat second pressing part 52. The thickness gradually increases towards ends in the side portions 100e of the sealed portion 100c, since the side portions 100e were pressed by the curved side portions 42b of the first pressing part 42 and the flat second pressing part 52.

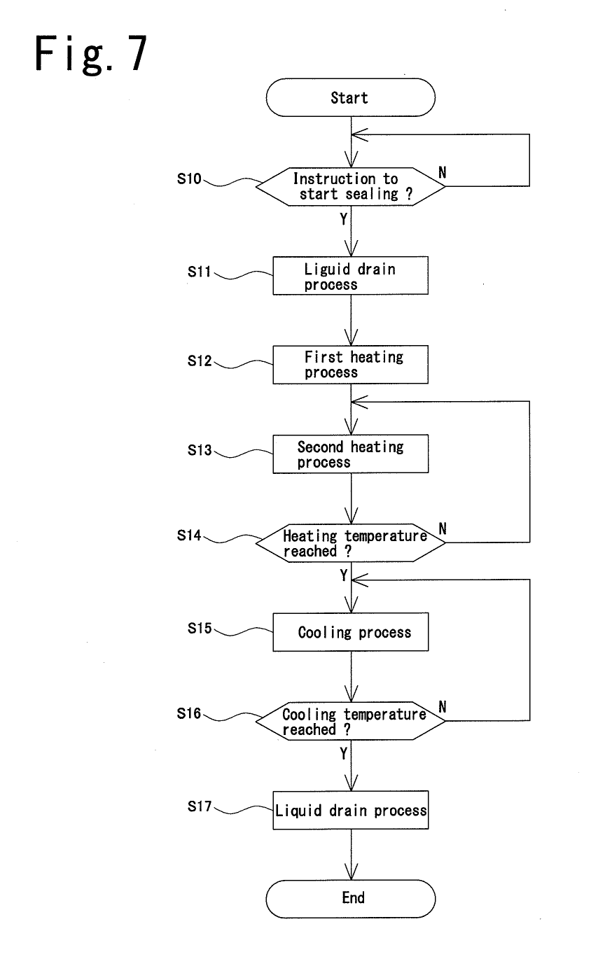

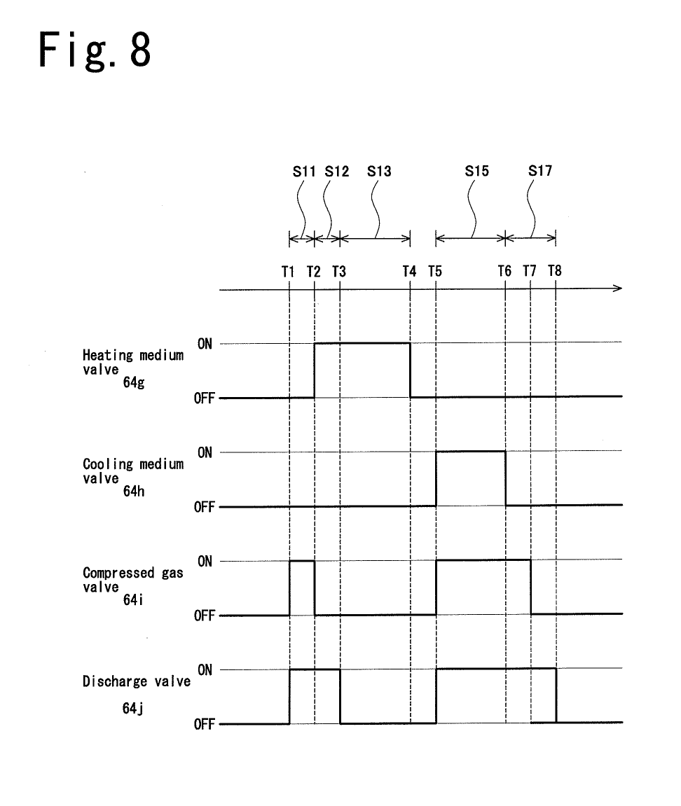

Next, the method of controlling the temperature of the first pressing part 42 in the seal device 1 according to this embodiment will be described with reference to FIG. 7 and FIG. 8.

When the operation part 10b is operated at time T1, whereupon an instruction to start sealing is received (Yes at S11), a discharge process (S12) is started, whereby the compressed gas valve 64i and the discharge valve 64j are opened. This causes the compressed air to be sent to the communication part 43 via the compressed gas passage portion 64c and the common passage portion 64d, so that water (condensed from the steam, and cold water) remaining in the communication part 43 of the first sealing unit 4 is drained from the communication part 43.

At time T2, a first heating process (S13) is started, wherein the heating medium valve 64g is opened, while the compressed gas valve 64i is closed. This causes the steam to be sent to the communication part 43 via the heating medium passage portion 64a and the common passage portion 64d, so that the first pressing part 42 is heated by the steam. At this time, the discharge valve 64j is kept open, so that the steam that has given up its heat to the first pressing part 42 (and the condensate water) is discharged from the communication part 43.

At time T3, a second heating process (S14) is started, wherein the discharge valve 64j is closed. This raises the pressure inside the communication part 43, and raises the temperature of the first pressing part 42. At time T4, the temperature detection unit 10a detects that the temperature of the first pressing part 42 has reached a preset heating temperature (Yes at S15), whereupon the heating medium valve 64g is closed.

At time T5, a cooling process (S16) is started, wherein the cooling medium valve 64h, compressed gas valve 64i, and discharge valve 64j are opened. This causes the cold water to be sent to the communication part 43 via the cooling medium passage portion 64b and the common passage portion 64d, and the compressed air to be sent to the communication part 43 with the cold water. The first pressing part 42 is cooled by the cold water, and then the cold water and compressed air are discharged from the communication part 43.

At time T6, the temperature detection unit 10a detects that the temperature of the first pressing part 42 has reached a preset cooling temperature (Yes at S17), whereupon the discharge process (S18) is started, so that the cooling medium valve 64h is closed. This causes only the compressed air to be sent to the communication part 43, so that the cold water inside the communication part 43 is drained from the communication part 43. After that, at time T7, the compressed gas valve 64i is closed, and at time T8, the discharge valve 64j is closed. This way, the first pressing part 42 is heated and cooled.

As described above, with the seal device 1 according to this embodiment, the passage switch unit 64e switches over to connect the heating medium passage portion 64a with the communication part 43 so as to send the heating medium from the heating medium passage portion 64a to the communication part 43. The first pressing part 42 is thereby heated, and the pair of pressing parts 42 and 52 sandwiches and presses the object 100 to provide a seal. At this time, the sealed portion 100c of the object 100 is molten.

The passage switch unit 64e then switches over to connect the cooling medium passage portion 64b with the communication part 43 so as to send the cooling medium from the cooling medium passage portion 64b to the communication part 43. The first pressing part 42 is thereby cooled, so that the molten sealed portion 100c cures. The object 100 can thus be sealed.

In this way, the seal device 1 according to this embodiment can be operated with improved efficiency. Moreover, no electrically driven components are used in the pair of sealing units 4 and 5, and so the seal device 1 according to this embodiment can also be used as an explosion-proof seal device 1.

In the seal device 1 according to this embodiment, the first pressing part 42 is supported in the first sealing unit body 41 so as to protrude from the first sealing unit body 41. In the side portions 42b of the first pressing part 42, the protruding amount W1 of the first pressing part 42 protruding from the first sealing unit body 41 decreases toward the ends, so that, in the sealed portion 100c of the object 100 pressed by the pair of pressing parts 42 and 52, the thickness of the side portions 100e increases gradually toward the ends. The object 100 can thus be sealed such that the side portions 100e of the sealed portion 100c are hard to tear.

In the seal device 1 according to this embodiment, by the switching of the passage switch unit 64e, the compressed gas is sent from the compressed gas passage portion 64c to the communication part 43 before the heating medium, which is a gas, is sent from the heating medium passage portion 64a to the communication part 43. Therefore, when the heating medium is sent to the communication part 43, any liquid (such as condensate liquid of the heating medium, or cooling medium, for example) is prevented from remaining inside the communication part 43. It is thereby prevented that the heating medium gives up its heat to such a liquid, so that the heat of the heating medium can be utilized effectively to heat the first pressing part 42.

In the seal device 1 according to this embodiment, the communication part 43 has an arcuate inner surface in the lower part, so that liquid remaining inside the communication part 43 (such as condensate liquid of the heating medium, or cooling medium, for example) is collected in the arcuate lower part of the communication part 43. Therefore, by sending the compressed gas from the compressed gas passage portion 64c to the communication part 43, such liquid can be drained reliably from the inside of the communication part 43. This way, any such liquid can be prevented from remaining inside the communication part 43 reliably when the heating medium is sent to the communication part 43.

In the seal device 1 according to this embodiment, when the cooling medium, which is a liquid, is sent from the cooling medium passage portion 64b to the communication part 43, the compressed gas is sent from the compressed gas passage portion 64c to the communication part 43 with the cooling medium by the switching of the passage switch unit 64e, so that the cooling medium mixes with the compressed gas. Thereby, with the cooling medium atomized, for example, the heat of evaporation (latent heat) effectively acts to lower the temperature of the first pressing part 42. The cooling medium can also create a turbulence, for example, inside the communication part 43 to provide a stirring effect, to make the temperature of the cooling medium uniform, whereby the heat exchange between the cooling medium and the first pressing part 42 takes place effectively.

The seal device is not limited to the configuration of the embodiment described above, and the effects are not limited to those described above. It goes without saying that the seal device can be variously modified without departing from the scope of the subject matter of the present invention. Not to mention, the configurations and methods or the like according to various modification examples described below, for example, may be freely selected and adopted to the configurations or methods of the embodiment described above.

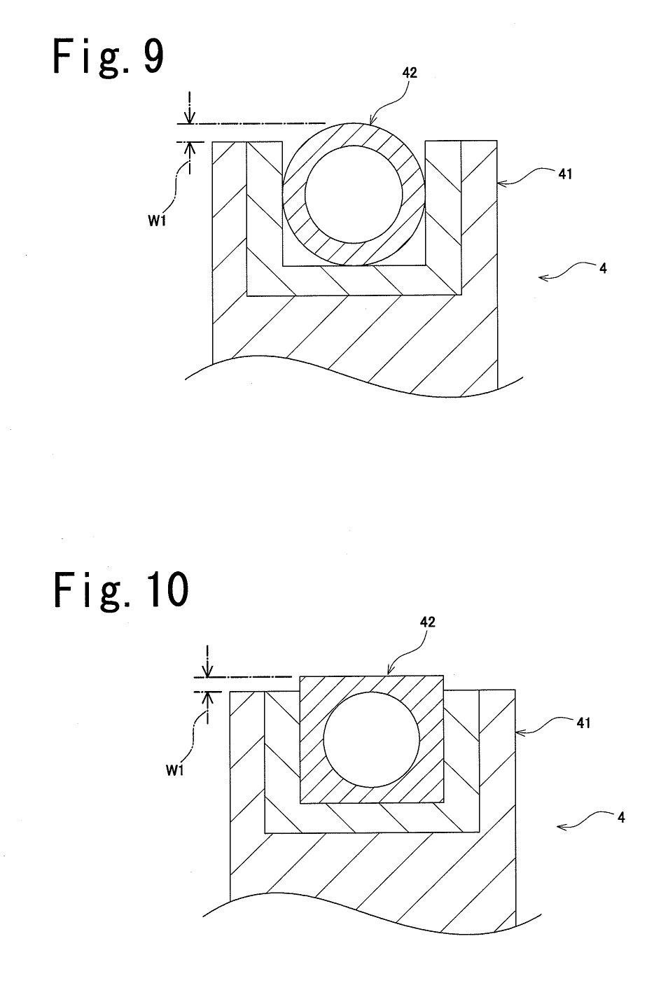

In the seal device 1 according to this embodiment, the side portions 42b of the first pressing part 42 are configured such that the protruding amount W1 from the first sealing unit body 41 decreases towards the ends. However, the seal device 1 according to the present invention is not limited to such a configuration. For example, in the seal device 1 according to the present invention, as shown in FIG. 9, the first pressing part 42 may be configured such that the protruding amount W1 from the first sealing unit body 41 entirely decreases towards the ends, or alternatively, as shown in FIG. 10, the first pressing part 42 may be configured to protrude from the first sealing unit body 41 entirely with the same protruding amount W1.

In the seal device 1 according to this embodiment, the side portions 42b of the first pressing part 42 are formed in a curved shape. However, the seal device 1 according to the present invention is not limited to such a configuration. For example, in the seal device 1 according to the present invention, the side portions 42b of the first pressing part 42 may be formed flat and intersect the central portion 42a at an angle.

In the seal device 1 according to this embodiment, the communication part 43 is provided only to the first sealing unit 4. However, the seal device 1 according to the present invention is not limited to such a configuration. For example, in the seal device 1 according to the present invention, the communication part 43 may be provided to both of the pair of sealing units 4 and 5.

In the seal device 1 according to this embodiment, only one communication part 43 is provided to the first sealing unit 4 for both of the heating medium and cooling medium to pass through. However, the seal device 1 according to the present invention is not limited to such a configuration. For example, the seal device 1 according to the present invention may be configured to include a plurality of communication parts 43, wherein each of the communication parts 43 allows passage of only one of the heating medium and the cooling medium.

In the seal device 1 according to this embodiment, the communication part 43 is formed to have arcuate inner surfaces in the lower part and in the sides. However, the seal device 1 according to the present invention is not limited to such a configuration. For example, in the seal device 1 according to the present invention, the communication part 43 may be formed to have an arcuate inner surface only in the lower part, or alternatively, the communication part 43 may be formed to have a flat inner surface in the lower part.

In the seal device 1 according to this embodiment, the heating medium is a gas (steam). However, the seal device 1 according to the present invention is not limited to such a configuration. For example, in the seal device 1 according to the present invention, the heating medium may be a liquid, and more specifically, hot water.

In the seal device 1 according to this embodiment, the cooling medium is a liquid (cold water). However, the seal device 1 according to the present invention is not limited to such a configuration. For example, in the seal device 1 according to the present invention, the cooling medium may be a gas.

In the seal device 1 according to this embodiment, only the second sealing unit 5 is movable. However, the seal device 1 according to the present invention is not limited to such a configuration. For example, the seal device 1 according to the present invention may be configured such that only the first sealing unit 4 is movable, or alternatively such that both of the pair of sealing units 4 and 5 are movable.

The seal device 1 according to the present invention may be configured to have a pre-heating process so as to raise the temperature of the first pressing part 42 to a predetermined level when the temperature lowers to a predetermined level during a wait time. In the pre-heating process, in the state in which all the valves 64g to 64j are closed, the heating medium valve 64g and the discharge valve 64j are opened, and after a predetermined time has passed, the heating medium valve 64g is closed while the compressed gas valve 64i is opened, and after a predetermined time has passed, the compressed gas valve 64i is closed, and after a predetermined time has further passed, the discharge valve 64j is closed.

The seal device 1 according to the present invention can be applied to any type of seal devices, as long as the seal device includes a pair of sealing units 4 and 5 having pressing parts 42 and 52 that sandwich and press an object 100 to provide a seal.

### DESCRIPTION OF REFERENCE SIGNS

1 Seal device
2 Device main body
3 Movable body
4 First sealing unit
5 Second sealing unit
6 Medium supply unit
7 Drive unit
8 Support unit
9 Pressure adjustment unit
10 Input unit
10a Temperature detection unit
10b Operation part
11 Control unit
41 First sealing unit body
41a Base part
41b Heat insulation part
42 First pressing part
42a Central portion
42b Side portion
43 Communication part
44 Pipe
51 Second sealing unit body
52 Second pressing part
61 Heating medium supply unit
61a Heating medium source
61b Supply passage
61c Pressure detection unit
62 Cooling medium supply unit
62a Cooling medium source
62b Tank
62c Supply passage
62d Valve
63 Compressed gas supply unit
63a Compressed gas source
63b Supply passage
63c Pressurizing passage
63d Pressure adjustment unit
63e Pressure adjustment unit
64 Medium passage
64a Heating medium passage portion
64b Cooling medium passage portion
64c Compressed gas passage portion
64d Common passage portion
64e Passage switch unit
64f Discharge passage portion
64g Heating medium valve
64h Cooling medium valve
64i Compressed gas valve
64j Discharge valve
100 Object
100a First portion
100b Second portion
100c Sealed portion
100d Central portion
100e Side portion
W1 Protruding amount

1. A sealing method comprising:
providing a seal device having:
first and second sealing units respectively having mutually opposing pressing parts for sandwiching and pressing an object disposed therebetween, wherein at least one of the first and second sealing units includes a communication part for receiving a heating medium to heat at least one of the pressing parts;
a heating medium valve, disposed upstream of the communication part, for sending the heating medium to the communication part so as to heat at least one of the pressing parts;
a cooling medium valve, disposed upstream of the communication part, for sending a cooling medium to the communication part so as to cool at least one of the pressing parts;
a compressed gas valve, disposed upstream of the communication part, for sending a compressed gas to the communication part;
a discharge valve disposed downstream of the communication part;
a control unit operatively connected to the valves to control opening and closing of the valves so as to send the heating medium, the cooling medium, and the compressed gas to the communication part;
inserting an object between the first and second sealing units; and
sandwiching the object between the opposing pressing parts;
at a first time, opening the discharge valve and the compressed gas valve to an open position, if not in an open position, to thereby send the compressed gas to the communication part;
at a second time later than the first time, closing the compressed gas valve and opening the heating medium valve to send the heating medium to the communication part;
at a third time later than the second time, closing the discharge valve while sending the heating medium to the communication part;
at a fourth time later than the third time, closing the heating medium valve;
at a fifth time later than the fourth time, opening the discharge valve, cooling medium valve, and the compressed gas valve to thereby send the cooling medium and the compressed gas to the communication part;
at a sixth time later than the fifth time, closing the cooling medium valve such that only the compressed gas is sent to the communication part;
at a seventh time later than the sixth time, closing the compressed gas valve; and
at an eighth time later than the seventh time, closing the discharge valve.

2. The method according to claim 1, wherein
at the fourth time, determining that at least one of the pressing parts has reached a preset heating temperature, and then closing the heating medium valve;
at the sixth time, determining that at least one of the pressing parts has reached a preset cooling temperature, and then closing the cooling medium valve such that only the compressed gas is sent to the communication part;

3. The method according to claim 2, wherein
the device includes a temperature detection unit associated with the communication part, and in communication with the control unit, and
the temperature detection unit is positioned and arranged to measure the temperature of the at least one of the pressing parts.

4. A sealing method comprising:
providing a seal device having:
first and second sealing units respectively having mutually opposing pressing parts for sandwiching and pressing an object disposed therebetween, wherein at least one of the first and second sealing units includes a communication part for receiving a heating medium to heat at least one of the pressing parts;
a heating medium valve, disposed upstream of the communication part, for sending the heating medium to the communication part so as to heat at least one of the pressing parts;
a compressed gas valve, disposed upstream of the communication part, for sending a compressed gas to the communication part;
a discharge valve disposed downstream of the communication part;
a control unit operatively connected to the valves to control opening and closing of the valves so as to send the heating medium and the compressed gas to the communication part;
inserting the object between the first and second sealing units; and
thereafter sandwiching the object between the mutually opposing pressing parts;
wherein the control unit thereafter instructs opening of the discharge valve and the compressed gas valve to send the compressed gas to the communication part;
wherein the control unit thereafter instructs closing of the compressed gas valve;
wherein the control unit thereafter instructs opening of the heating medium valve to send the heating medium to the communication part and thereby heat at least one of the pressing parts while the discharge valve is opened;
wherein the control unit thereafter instructs closing of the discharge valve while sending the heating medium to the communication part; and
wherein the control unit thereafter instructs closing of the heating medium valve.

5. A sealing method comprising:
providing a seal device having:
first and second sealing units respectively having mutually opposing pressing parts for sandwiching and pressing an object disposed therebetween, wherein at least one of the first and second sealing units includes a communication part for receiving a heating medium to heat at least one of the pressing parts;
a heating medium valve, disposed upstream of the communication part, for sending the heating medium to the communication part so as to heat at least one of the pressing parts;
a cooling medium valve, disposed upstream of the communication part, for sending a cooling medium to the communication part so as to cool at least one of the pressing parts;
a compressed gas valve, disposed upstream of the communication part, for sending a compressed gas to the communication part;
a control unit operatively connected to the valves to control opening and closing of the valves so as to send the heating medium, the cooling medium, and the compressed gas to the communication part;
thereafter inserting the object between the first and second sealing units; and
thereafter sandwiching the object between the mutually opposing pressing parts;
wherein the control unit thereafter instructs opening of the heating medium valve to send the heating medium to the communication part and thereby heat at least one of the pressing parts;
wherein the control unit thereafter instructs closing of the heating medium valve;
wherein the control unit thereafter instructs opening of the compressed gas valve and the cooling medium valve to send the cooling medium and the compressed gas to the communication part simultaneously to cool the communication part;
wherein the control unit thereafter instructs closing of the cooling medium valve while sending the compressed gas to the communication part; and
wherein the control unit thereafter instructs closing of the compressed gas valve.

6. The method according to claim 4, further comprises:
detecting a temperature of the at least one of the pressing parts to which the heating medium has been sent, and
wherein the control unit thereafter instructs closing of the heating medium valve after the at least one of the pressing parts has reached a preset temperature.

7. The method according to claim 6, wherein
the device includes a temperature detection unit associated with the communication part, and in communication with the control unit, and
the temperature detection unit is positioned and arranged to measure the temperature of the at least one of the pressing parts.

8. The method according to claim 4,
wherein the control unit instructs opening of the discharge valve and the compressed gas valve simultaneously to thereby send compressed gas to the communication part such that any medium remaining in the communication part is discharged through the discharge valve.

9. The method according to claim 4,
wherein the control unit instructs closing of the compressed gas valve and opening of the heating medium valve after a predetermined time has passed in a state in which the discharge valve and the compressed gas valve are opened, so as to thereby send the heating medium to the communication part, while maintaining the discharge valve in an opened state.

10. The method according to claim 4,
wherein the control unit instructs closing of the discharge valve after a predetermined time has passed in a state in which the heating medium valve is opened; and
wherein the control unit instructs closing of the heating medium valve after a predetermined time has passed in a state in which the discharge valve is closed.

11. The method according to claim 5, further comprises:
detecting a temperature of the at least one of the pressing parts to which the cooling medium has been sent, and
wherein the control unit thereafter instructs closing of the cooling medium valve after the at least one of the pressing parts has reached a preset temperature.

12. The method according to claim 11, wherein
the device includes a temperature detection unit associated with the communication part, and in communication with the control unit, and
the temperature detection unit is positioned and arranged to measure the temperature of the at least one of the pressing parts.

13. The method according to claim 5,
wherein the control unit instructs opening of the compressed gas valve and the cooling medium valve simultaneously to send the cooling medium and the compressed gas to the communication part simultaneously to cool the communication part.

14. The method according to claim 5,
wherein the control unit instructs opening of the compressed gas valve and the cooling medium valve to send the cooling medium and the compressed gas to the communication part simultaneously to cool the communication part;
wherein the control unit instructs closing of the cooling medium valve while sending the compressed gas to the communication part, after a predetermined time has passed in a state in which the cooling medium valve and the compressed gas valve are opened; and
wherein the control unit instructs closing of the compressed gas valve after a predetermined time has passed in a state in which the cooling medium valve is closed.
